(19) United States
(12) Patent Application Publication
(10) Pub. No.: US 2011/0091264 A1
(43) Pub. Date: Apr. 21, 2011

(54) COSMETIC DISPENSER WITH VIBRATION DEVICE

(76) Inventor: Jun ZHANG, Sijhih City (TW)

(21) Appl. No.: 12/580,359

(22) Filed: Oct. 16, 2009

(51) Int. Cl. A45D 40/26; B43K 29/00; B43K 5/00

(52) U.S. Cl. 401/139; 401/195; 401/202; 401/208

(57) ABSTRACT

A cosmetic dispenser includes a cap; a dispensing assembly in the cap and comprising a spring-biased plunger having a channel therethrough, and a dispensing seat releasably secured to the plunger; a case with the dispensing assembly disposed therein and comprising a peripheral communicating hole; a preparation container threadedly secured to the cap; a battery barrel; a push button switch in the battery barrel; a battery in the battery barrel between the switch and a motor; and a motor receptacle threadedly secured to the battery barrel and secured to the container. In an on operation, pressing a push button of the switch one time will electrically connect the battery and the motor together and activate the motor to cause vibration.

### BACKGROUND OF THE INVENTION

1. Field of Invention

The invention relates to cosmetic containers and more particularly to a cosmetic dispenser having a vibration device for massage.

2. Description of Related Art

A conventional cosmetic dispenser (e.g., deodorant or antiperspirant dispenser) is shown in FIGS. 7 and 8. The cosmetic dispenser comprises a container 1, a tube-like member 2, and a cap 5. The tube-like member 2 has a channel 3 therethrough, and a roller ball 4 is disposed inside the channel 3. The container 1 contains a quantity of preparation (e.g., lotion, salve, cosmetic liquid, or the like) and has a top opening to accommodate the tube-like member 2. The top opening of the container 1 is disposed with outer threads and the cap 5 has internal threads; the internal threads of the cap 5 secure to the outer threads of the container 1.

However, the well-known cosmetic dispenser suffers from several disadvantages. For example, it does not have a vibration device. Hence, no massage effect is produced. Moreover, it is not leak-proof. For example, preparation may spill out of the container 1 if it is held upside down or being squeezed due to inadvertence. Unfortunately, it is a tedious job to clean the leaked preparation. In addition, the volume of the dispensed preparation is not constant per application. It happens quite often that too much preparation is dispensed in a single application. This is a waste. Additionally, dirty liquid or the like may inadvertently flow into the container 1 to contaminate the preparation inside the container if preparation can be dispensed only by pressing the roller ball 4. Thus, the need for improvement still exists.

### SUMMARY OF THE INVENTION

It is therefore one object of the invention to provide a cosmetic dispenser comprising a cap, the cap comprises an internal space and an internally threaded section; a dispensing assembly disposed in the space of the cap and comprising a spring-biased plunger having a channel therethrough, and a dispensing seat releasably secured to the plunger; a case comprising an internal space with the dispensing assembly disposed therein, a communicating hole in communication with the space thereof, and an annular flange opposite the communicating hole; a container comprising an internal space for containing a quantity of preparation, and an externally threaded neck on a surface of a projecting open first end wherein the externally threaded neck is secured to the internally threaded section, and the flange is rested upon the externally threaded neck with the case being disposed in both the cap and the container; a battery barrel comprising an internal space and internal threads; a motor partially mounted in the space of the battery barrel; a switch comprising a push button exposed at one end of the battery barrel, the switch being mounted in the space of the battery barrel and being proximate to one end of the battery barrel; a conductor mounted in the space of the battery barrel and having both ends electrically connected to the switch and the motor respectively; a battery mounted in the space of the battery barrel between the switch and the motor, the battery mounted having positive and negative terminals electrically connected to the switch and the motor respectively; and a motor receptacle comprising an open first end releasably secured to the container, an open second end, and external threads on the second end, the external threads being threadedly engaged with the internal threads of the battery barrel to assemble the motor receptacle and the battery barrel together, and the motor being disposed in the motor receptacle; whereby in a preparation dispensing operation unfastening and removing the cap the plunger will axially move to clear the communicating hole so that the preparation flows from the space of the container to the dispensing seat through the communicating hole and the channel; whereby in a preparation stopping operation closing the cap onto the container and fastening same will cause the plunger to block the communicating hole; whereby in an on operation pressing the push button will electrically connect the battery, the motor, and the conductor together and activate the motor to cause vibration; and whereby in an off operation pressing the push button again will electrically disconnect the battery from the motor and deactivate the motor.

The above and other objects, features and advantages of the invention will become apparent from the following detailed description taken with the accompanying drawings.

### BRIEF DESCRIPTION OF THE DRAWINGS

FIG. 1 is a perspective view of the first preferred embodiment of a cosmetic dispenser according to the invention;

FIG. 2 is an exploded view of the cosmetic dispenser;

FIG. 3 is a longitudinal sectional view of FIG. 1;

FIG. 4 is an enlarged view of the lower portion of FIG. 3 schematically showing vibration effect of the cosmetic dispenser;

FIG. 5 is an enlarged view of the upper portion of FIG. 3 showing the preparation dispensing path of the cosmetic dispenser;

FIG. 6 is a view similar to FIG. 5 showing the second preferred embodiment of a cosmetic dispenser according to the invention;

FIG. 7 is an exploded view of a conventional cosmetic dispenser; and

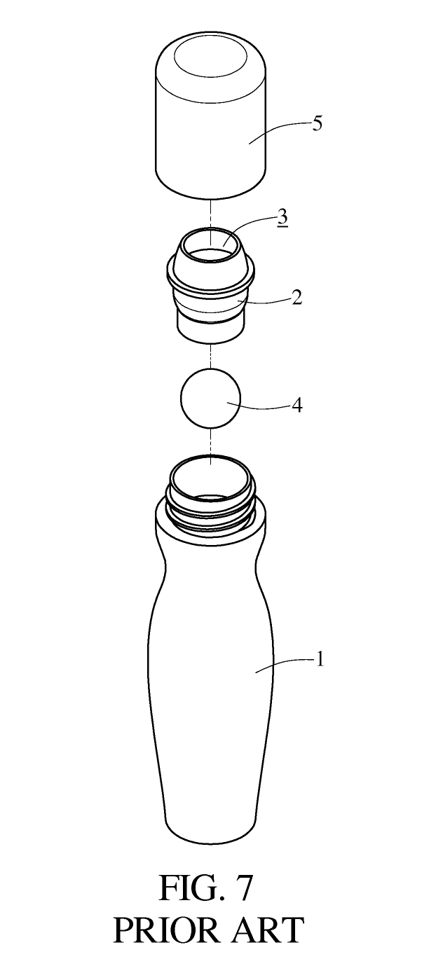

FIG. 8 is a longitudinal sectional view of the assembled cosmetic dispenser of FIG. 7 with the cap removed.

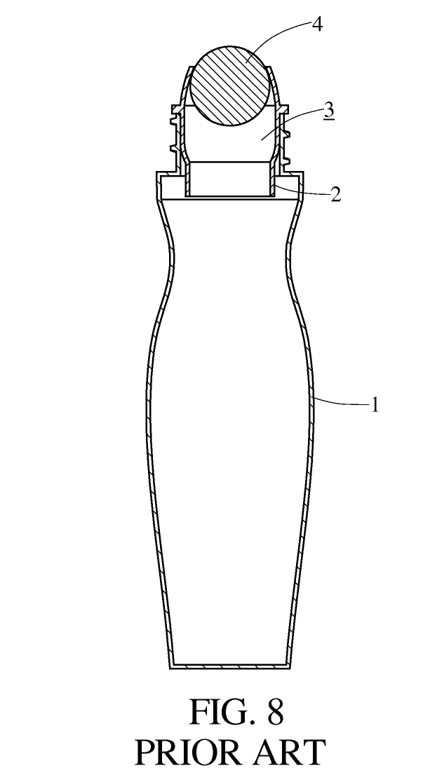

### DETAILED DESCRIPTION OF THE INVENTION

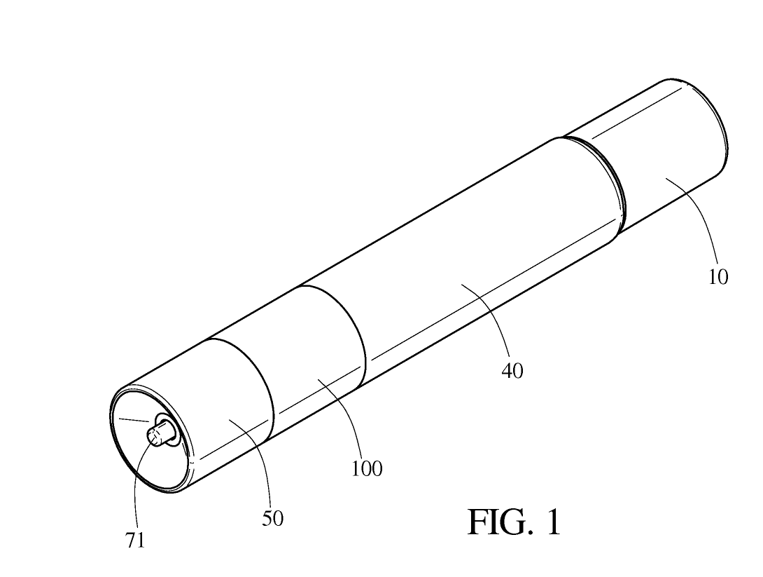

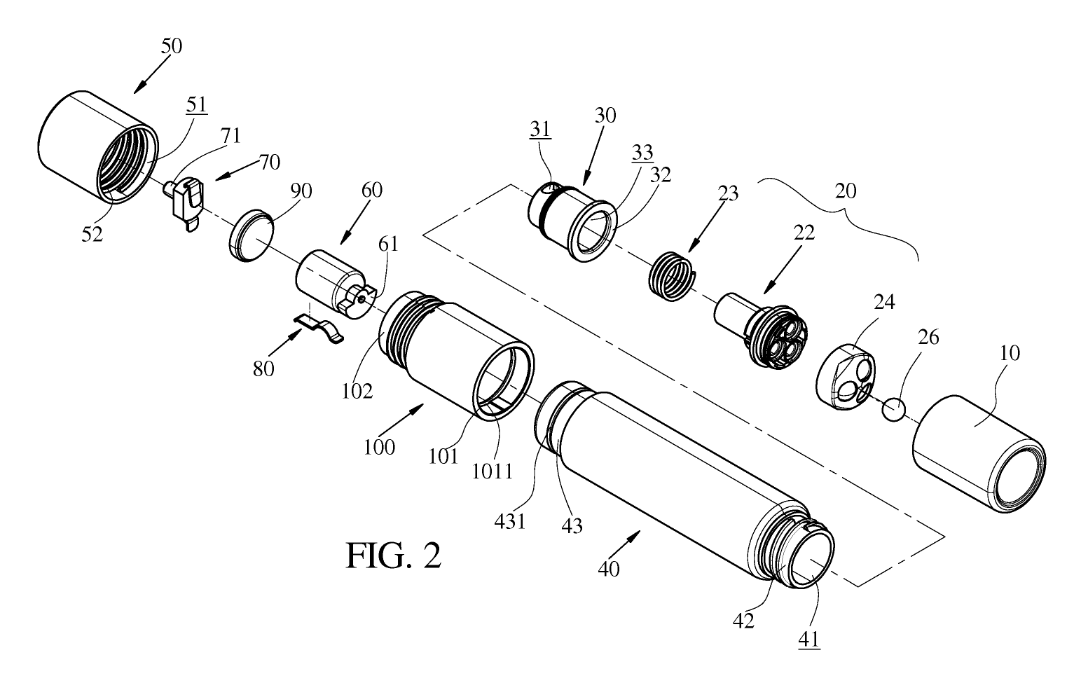

Referring to FIGS. 1 to 5, a cosmetic dispenser in accordance with the first preferred embodiment of the invention is shown. The cosmetic dispenser is cylindrical and comprises a cap 10, a dispensing assembly 20, a case 30, a container 40, a battery barrel 50, a motor 60, a switch 70, a conductor 80, a battery 90, and a motor receptacle 100. Each of the above components will now be described in detail below.

The cap 10 has a closed upper end and an open lower end. The cap 10 comprises an internal space 11 and an internally threaded section 12 at its lower end. The dispensing assembly 20 comprises a hollow plunger 22 having a channel 21 therethrough, a dispensing seat 24 threadedly secured to the plunger 22, a plurality of (three) roller balls 26 rotatably retained at a plurality of (three) holes (not numbered) of the dispensing seat 24 respectively, and a helical spring 23 put on the plunger 22. The case 30 is cylindrical and has a closed lower end and an open upper end. The case 30 comprises an internal space 33, a communicating hole 31 at the lower end in communicating with the space 33 and the exterior, and an annular flange 32 at the upper end. The lower end of the plunger 22 is fastened at the bottom of the case 30 and the spring 23 is disposed and biased in a space defined between the case 30 and the plunger 22 when the plunger 22 is disposed in the case 30.

The container 40 comprises an internal space 41 for containing a quantity of preparation, an externally threaded neck 42 on a surface of a projecting open upper end, and an annular groove 431 on a surface of a projecting closed lower end. The externally threaded neck 42 is secured to the internally threaded section 12, and the flange 32 is rested upon the upper end of the externally threaded neck 42 with the dispensing assembly 20 and the case 30 being assembled in the space 11 and an upper portion of the container 40 when the cap 10 is closed onto the container 40.

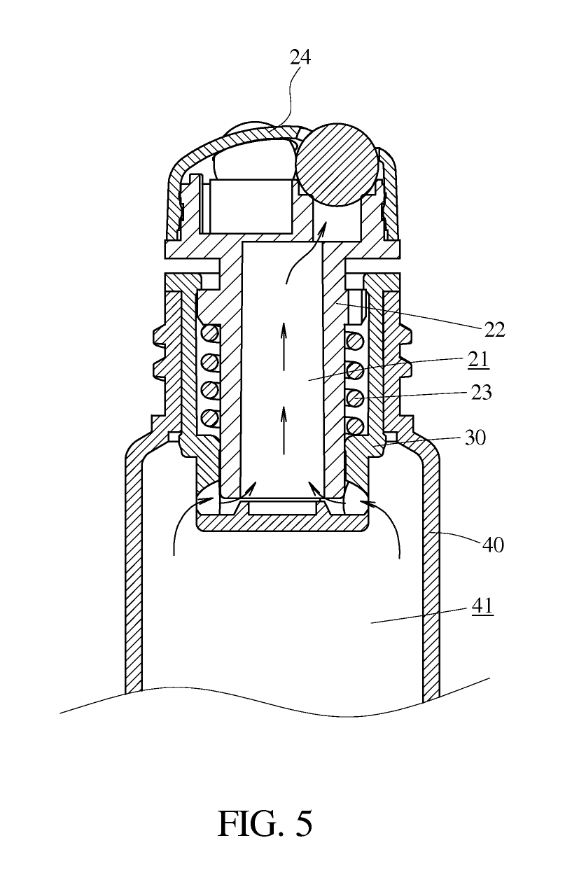

For flowing the preparation from the space 41 to the channel 21 in a preparation dispensing operation, a user can unfasten and remove the cap 10. The compressed spring 23 thus automatically expands to push the plunger 22 upward. As such, the communicating hole 31 is not blocked by the plunger 22. The user then may rotate the roller balls 26. As a result, the preparation flows from the space 41 to the exterior through the communicating hole 31, the channel 21, and the surfaces of the rotating roller balls 26 (see FIG. 5).

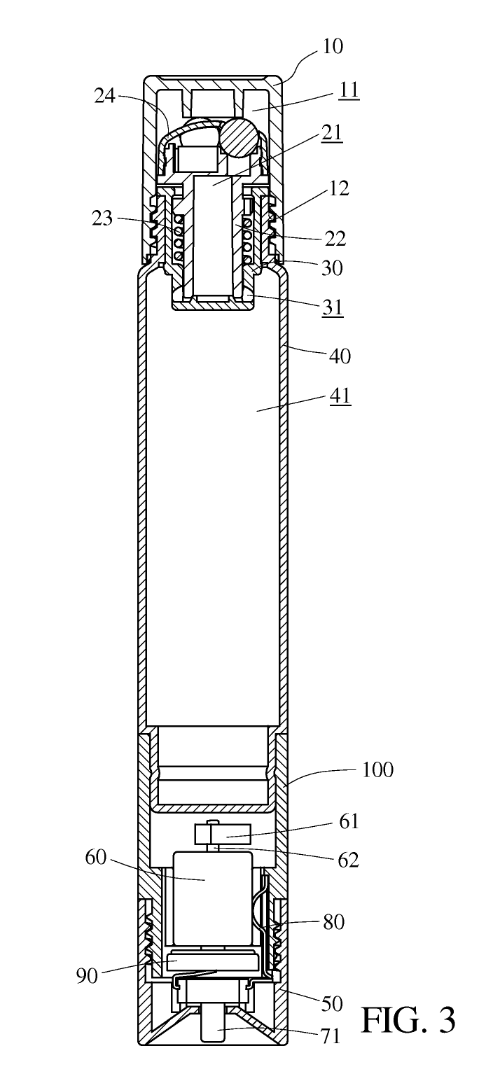

To the contrary, for stopping the flow of the preparation from the space 41 to the channel 21, the user can close the cap 10 onto the container 40 and fasten same by threading. The communicating hole 31 is thus blocked by the downwardly moved plunger 22 with the spring 23 being compressed (see FIGS. 1 and 3). In brief, the communicating hole 31 and the plunger 22 together function as a valve.

The battery barrel 50 is hollow and comprises an internal space 51, internal threads 52, and a hole (not numbered) at a lower end. The motor 60 is mounted in the space 51. The switch 70 is a conventional electronic push button switch and has a positive terminal and a negative terminal The switch 70 comprises a push button 71 projecting through the hole of the battery barrel 50 to be exposed. The switch 70 is also mounted in the space 51 and is proximate to the lower end of the battery barrel 50. The conductor 80 is also mounted in the space 51 and has both ends electrically connected to the switch 70 and the motor 60 respectively.

The battery 90 is also mounted in the space 51. The battery 90 is disposed between the switch 70 and the motor 60 and has both terminals (i.e., positive and negative terminals) electrically connected to the switch 70 and the motor 60 respectively. The motor receptacle 100 is a hollow cylinder and comprises an open upper end 101, an internal annular ridge 1011 proximate to the upper end 101, the ridge 1011 being matingly engaged with the groove 431 to assemble the motor receptacle 100 and the container 40 together, an open lower end 102, and external threads (not numbered) on the lower end 102, the external threads being threadedly engaged with the internal threads 52 to assemble the motor receptacle 100 and the battery barrel 50 together. The motor 60 is mounted in the motor receptacle 100 and comprises a driving shaft 62 and a cam member 61 mounted on an open end of the driving shaft 62, the cam member 61 being proximate to the bottom of the container 40.

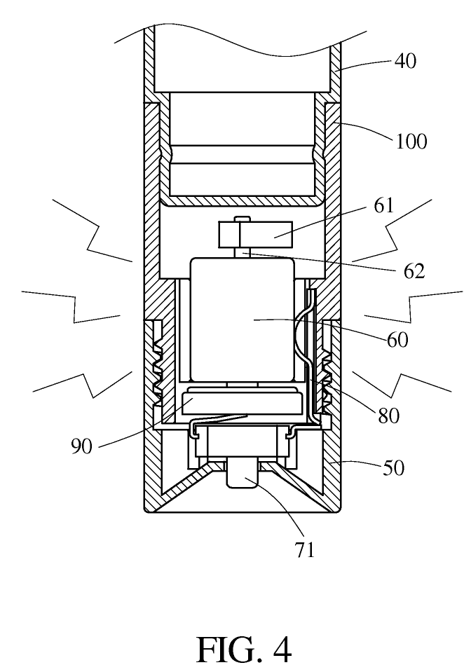

The cosmetic dispenser operates as follows. A user can press the push button 71 one time (i.e., the switch 70 is in an on position) to electrically connect the battery 90, the motor 60, and the conductor 80 together. Hence, the motor 60 is activated to continuously rotate the cam member 61 via the driving shaft 62. As a result, a vibration (i.e., massage) effect is produced at a lower portion of the cosmetic dispenser (see FIG. 4). To the contrary, pressing the push button 71 again (i.e., the switch 70 is in an off position) will electrically disconnect the battery 90 from the motor 60. Hence, the motor 60 is deactivated with the rotation of the cam member 61 being stopped.

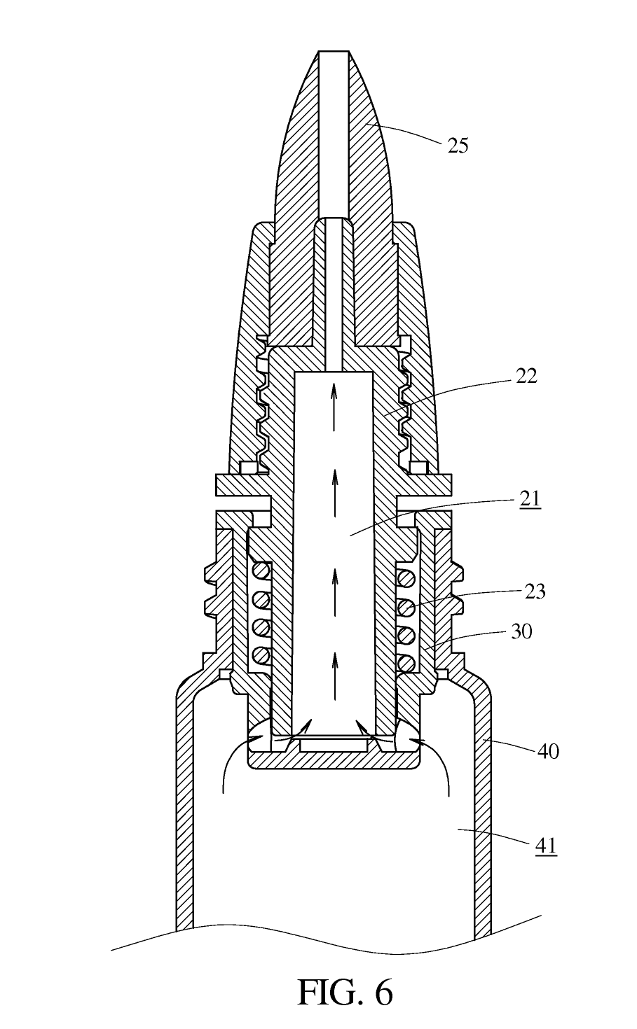

Referring to FIG. 6, a cosmetic dispenser in accordance with the second preferred embodiment of the invention is shown. The second embodiment is identical to the first embodiment, except that the dispensing seat 24 and an upper portion of the plunger 22 of the first embodiment are replaced with a hollow sponge member 25. Preparation can flow from the space 41 to the exterior through the channel 21 and the hollow sponge member 25 in a preparation dispensing operation.

The invention has the following advantages. In addition to typical preparation dispensing function, it has vibration (i.e., massage) function. Thus, the cosmetic effect is more significant. Further, the volume of dispensed preparation is precisely controlled by a valve comprising the communicating hole 31 and the plunger 22. Furthermore, no preparation leakage is possible.

While the invention herein disclosed has been described by means of specific embodiments, numerous modifications and variations could be made thereto by those skilled in the art without departing from the scope and spirit of the invention set forth in the claims.

What is claimed is:

1. A cosmetic dispenser comprising:
a cap comprising an internal space and an internally threaded section;
a dispensing assembly disposed in the space of the cap and comprising a spring-biased plunger having a channel therethrough, and a dispensing seat releasably secured to the plunger;
a case comprising an internal space with the dispensing assembly disposed therein, a communicating hole in communication with the space thereof, and an annular flange opposite the communicating hole;
a container comprising an internal space for containing a quantity of preparation, and an externally threaded neck on a surface of a projecting open first end wherein the externally threaded neck is secured to the internally threaded section, and the flange is rested upon the externally threaded neck with the case being disposed in both the cap and the container;
a battery barrel comprising an internal space and internal threads;
a motor partially mounted in the space of the battery barrel;
a switch comprising a push button exposed at one end of the battery barrel, the switch being mounted in the space of the battery barrel and being proximate to one end of the battery barrel;
a conductor mounted in the space of the battery barrel and having both ends electrically connected to the switch and the motor respectively;
a battery mounted in the space of the battery barrel between the switch and the motor, the battery mounted having positive and negative terminals electrically connected to the switch and the motor respectively; and
a motor receptacle comprising an open first end releasably secured to the container, an open second end, and external threads on the second end, the external threads being threadedly engaged with the internal threads of the battery barrel to assemble the motor receptacle and the battery barrel together, and the motor being disposed in the motor receptacle;
whereby in a preparation dispensing operation unfastening and removing the cap the plunger axially moves to clear the communicating hole so that the preparation flows from the space of the container to the dispensing seat through the communicating hole and the channel;
whereby in a preparation stopping operation closing the cap onto the container and fastening the same causes the plunger to block the communicating hole;
whereby in an on operation, pressing the push button electrically connects the battery, the motor, and the conductor together and activates the motor to cause vibration; and
whereby in an off operation, pressing the push button again electrically disconnects the battery from the motor and deactivates the motor.

2. The cosmetic dispenser of claim 1, wherein the motor comprises a driving shaft and a cam member mounted on an open end of the driving shaft.

3. The cosmetic dispenser of claim 1, wherein the plunger comprises a spring means disposed and biased in a space defined between the case and the plunger.

4. The cosmetic dispenser of claim 1, wherein the dispensing seat comprises at least one roller ball.

5. The cosmetic dispenser of claim 1, wherein the dispensing seat is a hollow sponge member.

6. The cosmetic dispenser of claim 1, wherein the switch is an electronic push button switch.

7. The cosmetic dispenser of claim 1, wherein the switch has a positive terminal and a negative terminal

8. The cosmetic dispenser of claim 1, wherein the container further comprises an annular groove on a surface of a projecting closed second end, and the motor receptacle further comprises an internal annular ridge proximate to the first end thereof, the ridge being matingly engaged with the groove to assemble the motor receptacle and the container together.
